(19) United States
(12) Patent Application Publication
(10) Pub. No.: US 2009/0232522 A1
(43) Pub. Date: Sep. 17, 2009

(54) PRINTING SYSTEM, CONTROL METHOD THEREFOR, AND STORAGE MEDIUM STORING CONTROL PROGRAM THEREFOR

(75) Inventor: Toru Takahashi, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/403,228

(22) Filed: Mar. 12, 2009

(30) Foreign Application Priority Data
Mar. 13, 2008 (JP) 2008-064577

(51) Int. Cl. G03G 15/00

(52) U.S. Cl. 399/19

(57) ABSTRACT

A printing system enabling a less wasteful and rapid printing restart for both cases where an interrupted job utilizes an ordered sheet, and where such a job utilizes a disordered sheet. A job processing unit executes a job outputting at least one sheet included in a set of a plurality of sheets in a case where sheets printed by a printing operation are outputted. A control unit controls to output, to a predetermined sheet-ejecting unit, a sheet which has not been outputted by the job processing unit among the set of a plurality of the sheets used by the job when the job executed by the job processing unit is interrupted. The job processing unit restarts to execute the interrupted job based on an instruction of a user after the sheet which has not been outputted by the job processing unit is outputted to the predetermined sheet-ejecting unit.

### BACKGROUND OF THE INVENTION

1. Field of the Invention

The present invention relates to a printing system configured to be able to execute a sheet removing operation when the printing is interrupted, a control method, and a storage medium storing a program for implementing the control method.

2. Description of the Related Art

A printing system of recent years is configured to be able to automatically restart the printing soon after an interrupt factor is eliminated by, for example, removing a jamming sheet when the printing is interrupted because of occurrence of the printing interrupt factor such as a sheet jam. Such a technique is, for example, disclosed in U.S. Pat. No. 7,126,719.

In such a system, when an ordered sheet, such as a tabbed index sheet (hereinafter, described as a tab sheet), is utilized when the printing is interrupted (at the timing just before the printing is interrupted), an incorrect operation may be executed when the printing is restarted.

For example, there exists such a problem that when an interrupted printing job is restarted, or another printing job is started after the interrupt factor is eliminated, the tab sheet, whose order is incorrect, is fed from a sheet feeder. As described above, there exists such a problem that an operation, which is not intended by a user, is executed after the printing is interrupted. There also exists such a problem that an operator executes an incorrect operation without knowing that the tab sheet with the incorrect order remains in the sheet feeder.

### SUMMARY OF THE INVENTION

In view of such a circumstance, the present invention provides a mechanism in which, even if a job utilizing an ordered sheet is interrupted, a disordered sheet which is not intended by a user is prevented from being supplied from sheet feeder after the interruption.

The present invention provides a mechanism in which the printing can be rapidly restarted in a less wasteful operation.

The present invention provides a mechanism enabling a less wasteful and rapid printing restart for both cases where an interrupted job utilizes an ordered sheet, and where such a job utilizes a disordered sheet.

Accordingly, the present invention provides a printing system comprising a job processing unit configured to execute a job outputting a set of a plurality of sheets in a case where sheets printed by a printing operation are outputted, and a control unit configured to control to output, to a predetermined sheet-ejecting unit, a sheet which has not been outputted by the job processing unit among the set of a plurality of the sheets used by the job when the job executed by the job processing unit is interrupted, wherein the job processing unit restarts to execute the interrupted job based on an instruction of a user after the sheet which has not been outputted by the job processing unit is outputted to the predetermined sheet-ejecting unit.

The present invention can provide a mechanism in which, even if a job utilizing an ordered sheet is interrupted, an incorrect action and an incorrect operation can be prevented in the system thereafter, and the high productivity is maintained.

The features and advantages of the invention will become more apparent from the following detailed description taken in conjunction with the accompanying drawings.

### BRIEF DESCRIPTION OF THE DRAWINGS

FIG. 1 is a schematic view showing a configuration of a POD system including a printing system according to an embodiment of the present invention.

FIG. 2 is a block diagram describing a configuration of the printing system of FIG. 1.

FIG. 3 is a cross sectional view of a printing apparatus and a sheet-processing apparatus connected to this printing apparatus in the printing system of FIG. 1.

FIG. 4 is an external view of an operation unit of the printing apparatus in FIG. 3.

FIG. 5 is a display screen view showing an exemplary screen displayed in a touch panel unit included in the operation unit of FIG. 4.

FIG. 6 is the display screen view showing a screen for setting material of a sheet displayed in the touch panel unit of FIG. 5.

FIG. 7 is the display screen view showing a screen for setting the number of divisions of a tab sheet displayed in the touch panel unit of FIG. 5.

FIG. 8 is the display screen view showing a screen for setting a remaining sheet removing operation function displayed in the touch panel unit of FIG. 5.

FIG. 9 is the display screen view showing a restart screen of a tab sheet job displayed in the touch panel unit of FIG. 5.

FIG. 10 is a schematic view showing an outline of the function of the remaining sheet removing operation in the printing apparatus of FIG. 3.

FIG. 11 is a flowchart showing a control flow of the remaining sheet removing operation in the printing apparatus of FIG. 3.

FIG. 12 is a schematic view showing an example of a first printing interrupt case in the printing apparatus of FIG. 3.

FIG. 13 is a schematic view showing job restarting control after the printing interruption shown in FIG. 12.

FIG. 14 is a schematic view showing an example of a second printing interrupt case in the printing apparatus in FIG. 3.

FIG. 15 is a schematic view showing the job restarting control after the printing interruption shown in FIG. 14.

FIG. 16 is a schematic view showing an example of a third printing interrupt case in the printing apparatus in FIG. 3.

FIG. 17 is a schematic view showing the job restarting control after the printing interruption shown in FIG. 16.

FIG. 18 is a flowchart showing a process when the printing is interrupted in the printing apparatus of FIG. 3.

FIG. 19 is a flowchart showing a process when the printing is restarted in the printing apparatus of FIG. 3.

FIG. 20 is a flowchart showing a process according to a modified example of the present embodiment.

FIG. 21 is a flowchart showing a process according to a modified example of the present embodiment.

### DESCRIPTION OF THE PREFERRED EMBODIMENTS

Embodiments of the present invention will be described below as referring to the figures.

<Configuration of POD System>

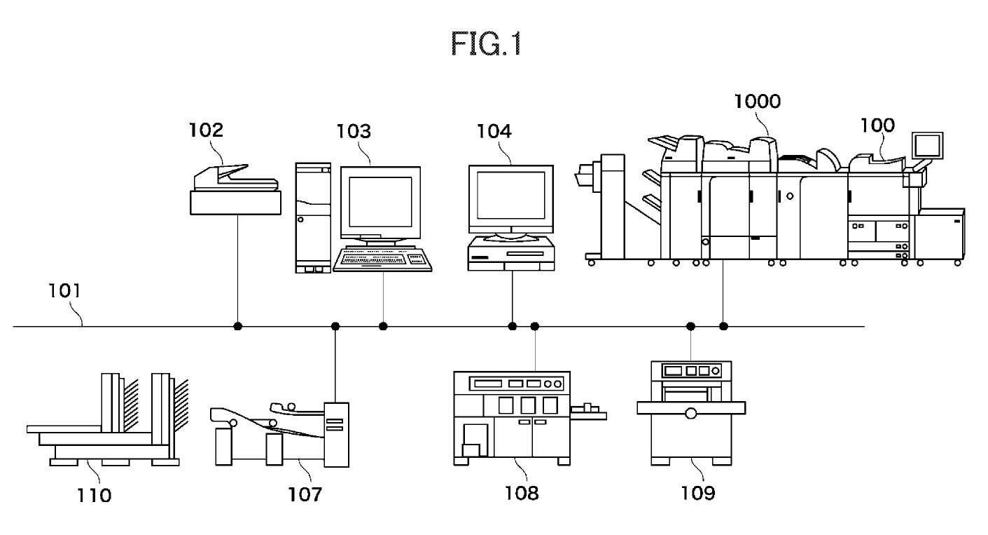

FIG. 1 is a schematic view showing a configuration of a POD system including a printing system according to the embodiment of the present invention.

This POD system includes a printing system 1000, a scanner 102, a server computer (PC) 103, and a client computer (PC) 104, which are connected through a network 101. This POD system further includes a sheet-folding machine 107, a perfect binder 108, a cutting machine 109, a saddle finisher 110, and the like.

The server PC 103 manages data to be transmitted and received to and from a variety of apparatuses connected to the network 101. The client PC 104 transmits image data to a printing apparatus 100 of the printing system 1000 and to the server PC 103 through the network 101. The sheet-folding machine 107 executes a folding process for a sheet printed by the printing apparatus 100. The perfect binder 108 executes a perfect binding process for the sheet printed by the printing apparatus 100. The cutting machine 109 executes a cutting process for the sheets printed by the printing apparatus 100 for each sheet bundle including a plurality of the sheets. The saddle finisher 110 executes a saddle stitching process for the sheet printed by the printing apparatus 100.

In the present embodiment, while the printing apparatus 100 functions as a binding processing apparatus, the present invention is not limited to such a case, but the server PC 103, the client PC 104, or any of post-processing apparatuses may execute this function.

When utilizing the sheet-folding machine 107, the perfect binder 108, the cutting machine 109, and the saddle finisher 110, a user picks up the sheet printed by the printing apparatus 100 from the printing system 1000 to set the picked-up sheet to an apparatus to utilize, and causes the apparatus to execute a process for the picked-up sheet. The apparatuses other than the saddle finisher 110 in a plurality of the apparatuses included by the POD system are connected to the network 101, and can mutually communicate data with other apparatuses.

Meanwhile, when the sheet printed by the apparatus other than the printing apparatus 100 is supplied, the sheet-folding machine 107, the perfect binder 108, the cutting machine 109, and the saddle finisher 110 also similarly execute a post process for such a sheet.

<Configuration of the Printing System>

(A) Block Configuration

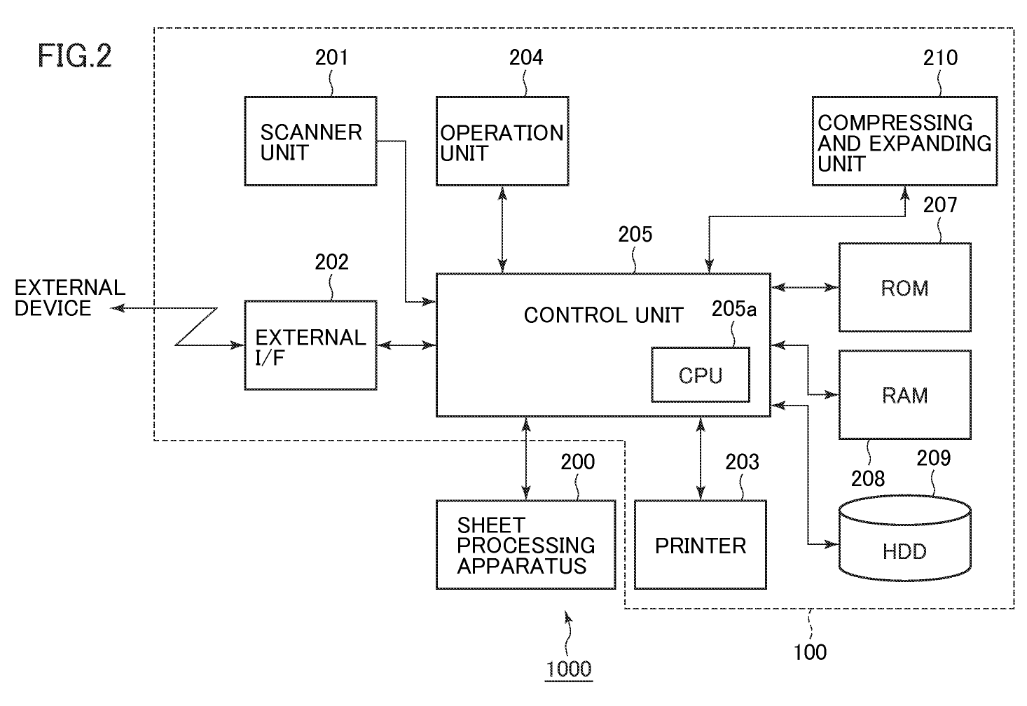

FIG. 2 is a block diagram describing a configuration of the printing system 1000 according to the present embodiment.

This printing system 1000 includes the printing apparatus 100 and a sheet-processing apparatus 200. Meanwhile, in the present embodiment, a multi function peripheral (MFP) including a plurality of functions such as a copying function and a printing function will be described as an example of the printing apparatus 100. However, this printing apparatus 100 may be a single function-type printing apparatus (printer) including only the copying function or only the printing function. Meanwhile, each unit, which is included in the printing system 1000, other than the sheet-processing apparatus 200 is included in the printing apparatus 100. Any number of the sheet-processing apparatuses 200 can be connected to the printing apparatus 100.

The printing system 1000 is configured so that a sheet processing for the sheet printed by the printing apparatus 100 can be executed by the sheet-processing apparatuses 200 connected to the printing apparatus 100. However, the printing system 1000 can be also configured with only the printing apparatus 100 without connecting the sheet-processing apparatuses 200.

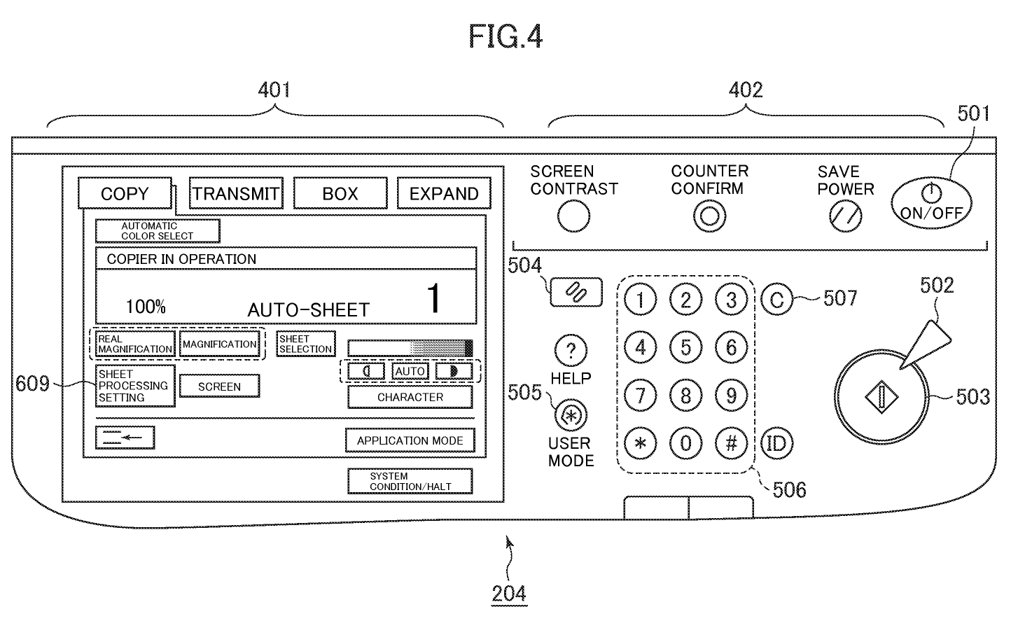

The sheet-processing apparatuses 200 is configured so as to be able to communicate with the printing apparatus 100, receives an instruction from the printing apparatus 100, and can execute an after-mentioned sheet process. A scanner unit 201 reads an image on an original document, converts the read image to image data, and transfers the image data to other unit. An external I/F 202 transmits and receives data to and from other apparatus connected to the network 101. A printer 203 prints an image based on the inputted image data on the sheet. An operation unit 204 includes a hard key input unit (key input unit) 402 (FIG. 4) and a touch panel unit 401 (FIG. 4), which will be after-mentioned, and receives the instruction from the user through such units. The operation unit 204 displays various types of information on a touch panel included by the operation unit 204.

A control unit 205 includes a CPU 205a, and totally controls a process, an operation and the like of a variety of the units included in the printing system 1000. That is, the control unit 205 also controls the operations of the printing apparatus 100 and the sheet-processing apparatuses 200 connected to the printing apparatus 100. A ROM 207 stores a variety of computer programs executed by the CPU 205a. For example, the ROM 207 stores a program for causing the control unit 205 to execute a variety of processes of after-mentioned flowcharts, and a display controlling program which is necessary to display a variety of after-mentioned setting screens. The ROM 207 also stores a program for the control unit 205 to interpret PDL (Page Description Language) code data received from the server PC 103, the client PC 104, and the like, and develop the received PDL code data to raster image data. The ROM 207 also stores a boot sequence, font information, and the like. A RAM 208 stores the image data transferred from the scanner unit 201 and the external I/F 202, and a variety of the programs loaded from the ROM 207 and setting information. The RAM 208 also stores information (the number of the sheet-processing apparatuses 200 connected to the printing apparatus 100, information regarding functions of each sheet-processing apparatuses 200, a connection order of each sheet-processing apparatuses 200, and the like) regarding the sheet-processing apparatuses 200. Meanwhile, the CPU 205a controls data to be written to the RAM 208, and to be read from the RAM 208.

A HDD (Hard Disk Drive) 209 is configured with a hard disk, a driving unit for reading and writing data from and to the hard disk, and the like. The HDD 209 is a large-capacity storage apparatus for storing the image data which is inputted from the scanner unit 201 or the external I/F 202, and is compressed by a compressing and expanding unit 210. The HDD 209 also stores a memory setting value (recommended setting value) of each after-mentioned item. The control unit 205, based on the instruction from the user, can output the image data stored in the HDD 209 to the printer 203 to print the outputted image data. The control unit 205, based on the instruction from the user, can also transmit the image data stored in the HDD 209 to an external apparatus such as the server PC 103 through the external I/F 202. A compressing and expanding unit 210 executes a compressing and expanding operation for the image data, and the like stored in the RAM 208 and the HDD 209 in a variety of compressing methods such as JBIG and JPEG.

(B) Cross-Sectional Configuration

(i) A Cross-Sectional Configuration of the Printing Apparatus

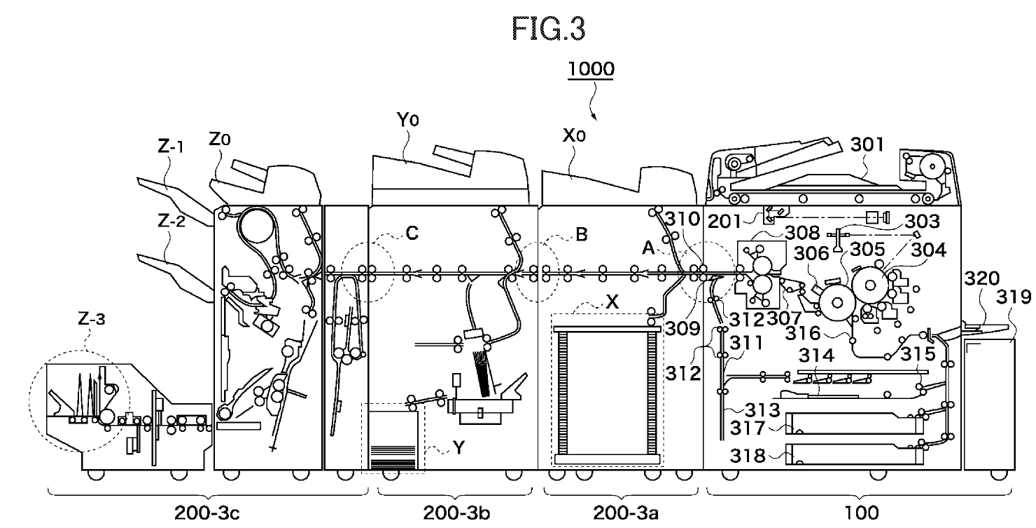

FIG. 3 is a cross sectional view of the printing apparatus 100 and the sheet-processing apparatus 200 connected to this printing apparatus 100 according to the present embodiment.

An automatic document feeder (ADF) 301 separates a document from a document bundle set on a mounting surface of a document tray in order of a page number from a document of the first page, and feeds the separated document on platen glass so that the document is scanned and read by the scanner unit 201. The scanner unit 201 reads the image of the document fed on the platen glass to convert the read image to image data with a CCD. A rotating multifaceted mirror (polygon mirror, or the like) 303 reflects and scans laser light modulated according to the image data to irradiate the modulated laser light to a photoconductive drum 304 through a reflection mirror. A latent image formed on the photoconductive drum 304 as described above is developed with toner, and a toner image is transferred to the sheet put on a transferring drum 305. A full-color image is transferred to the sheet by sequentially executing a series of such image forming processes for toners of yellow (Y), magenta (M), cyan (C), and black (K).

As described above, the sheet, to which the full-color image is transferred, on the transferring drum 305 is separated from the transferring drum 305 by a separating claw 306, and is fed to a fixing unit 308 by a pre-fixing feeding unit 307. The fixing unit 308 is configured with a combination of a roller and a belt, incorporates a heat source such as a halogen heater, and solves the toner on the sheet, to which the toner image is transferred, with heat and pressure, and fixes the toner image. A sheet-ejecting flapper 309 is configured so as to be able to rock around a rocking axis, and defines a direction for feeding the sheet. While the sheet-ejecting flapper 309 is rotating in a clockwise direction in the figure, the sheet is straightly fed, and is ejected by a sheet-ejecting roller 310 to an outside of the apparatus. The control unit 205 controls the printing apparatus 100 so as to execute a single side printing in a series of above sequences.

On the other hand, when the images are formed on both sides of the sheet, the sheet-ejecting flapper 309 rotates in a counter clockwise direction in the figure, and the sheet is transferred to a both-side-feeding unit by changing a course to a downward direction. The both-side-feeding unit is provided with an inverting flapper 311, an inverting roller 312, an inverting guide 313, and a both-side tray 314. The inverting flapper 311 rotates around a rotation axis to define a feeding direction of the sheet.

When processing a both side printing job, the control unit 205 controls to print a first side of the sheet with the printer 203, and to transfer the printed sheet to the inverting guide 313 through the inverting roller 312. Next, the control unit 205 causes the inverting roller 312 to temporarily stop rotating while a back end of the sheet is being tightly held by the inverting roller 312, continuously causes the inverting flapper 311 to rotate in a clockwise direction in the figure, and causes the inverting roller 312 to rotate in an inverse direction. Thereby, the control unit 205 causes the sheet to be switched back and fed, and controls this sheet to be led to the both side tray 314 in such a condition that a back end and a front end of the sheet are replaced. After being temporarily mounted on the both side tray 314, the sheet is transferred again by a sheet re-feeding roller 315 to a resist roller 316. In this case, the sheet is fed as an opposite side from a transferring step of the first side is facing the photoconductive drum 304. In a similar way to the above process, an image of a second side is transferred to the second side of the sheet. Next, the images are formed on the both sides of the sheet, and the sheet is passed through a fixing step to be ejected from an inside of a main body of the printing apparatus 100 to an outside of the apparatus through the sheet-ejecting roller 310. The control unit 205 controls the printing apparatus 100 to execute the both-side printing in a series of the above sequences.

The printing apparatus 100 includes a sheet feeder storing the sheets which are necessary for the printing process. The sheet feeder includes sheet-feeding cassettes 317 and 318 (for example, each one can store 500 sheets), a sheet-feeding deck 319 (for example, this can store 5000 sheets), a hand-feeding tray 320, and the like. A variety of the sheets, whose sizes and materials are different from each other, including tab sheets used in the present embodiment can be separately set in each of the sheet-feeding cassettes 317 and 318, and the sheet-feeding deck 319.

A variety of the sheets including the special sheet such as an OHP sheet can be set in the hand-feeding tray 320. A sheet-feeding roller is provided in each of the sheet-feeding cassettes 317 and 318, the sheet-feeding deck 319, and the hand-feeding tray 320, and each of the sheets is continuously fed by the rotation of this sheet-feeding roller.

(ii) A Cross-Sectional Configuration of the Sheet-Processing Apparatus

Next, the sheet-processing apparatus 200 shown in FIG. 3 will be described.

If the sheet can be fed from an upstream apparatus to a downstream apparatus through a sheet-feeding path, the sheet-processing apparatuses 200, whose type and number are arbitrary, in the printing system 1000 according to the present embodiment can be connected. For example, as shown in FIG. 3, in the order of the nearest position to the printing apparatus 100, a large-capacity stacker 200-3a, a gluing-binding machine 200-3b, and a saddle finisher 200-3c can be connected in such an order, and each of such apparatuses can be selectively utilized by the printing system 1000. Each of the sheet-processing apparatuses 200 is provided with a sheet-ejecting unit, and the user can pick up the sheet which has been sheet-processed from the sheet-ejecting unit of each sheet-processing apparatus.

The control unit 205 receives an execution request for the sheet processing, whose type is desired by the user, from candidates of the sheet processing which can be executed by the sheet-processing apparatus 200 connected to the printing apparatus 100 along with a printing execution request through the operation unit 204. As responding to such a fact that the printing execution request of a job to be processed is received from the user through the operation unit 204, the control unit 205 causes the printer 203 to execute the printing process needed by the job. The control unit 205 causes the sheet of the job, whose printing process has been executed, to be fed to the sheet-processing apparatus, which can execute the sheet-processing desired by the user, through the sheet-feeding path, and causes such a sheet-processing apparatus to execute the sheet-processing.

For example, it is assumed that the printing system 1000 has the system configuration shown in FIG. 3, and that the job to be processed, whose printing execution request is received from the user, is the job which is instructed to execute a large amount stacking process by the large-capacity stacker 200-3a. This job is referred to as “stacker job”. When this stacker job is processed by the printing system 1000 of FIG. 3, the control unit 205 causes the sheet, which is printed by the printing apparatus 100, of this job to be fed to an inside of the large-capacity stacker 200-3a through a point A of FIG. 3. After that, the control unit 205 causes the large-capacity stacker 200-3a to execute the stacking process of this job. The control unit 205 does not feed the printed sheet, which is processed by the stacking process in the large-capacity stacker 200-3a, to other apparatus (for example, the apparatus in a post-stage), but causes the printed sheet to be held in a sheet-ejecting destination X inside the large-capacity stacker 200-3a.

This printed sheet held in the sheet-ejecting destination X of FIG. 3 can be directly picked up by the user from the sheet-ejecting destination X. This eliminates such a work of feeding the sheet in a sheet feeding direction of FIG. 3 to the most downstream ejecting destination (any of Z-1, Z-2, and Z-3) and taking the printed sheet from such a sheet-ejecting destination (any of Z-1, Z-2, and Z-3).

In FIG. 3, it is assumed that the job to be processed, whose printing execution request is received from the user, is the job which is instructed to execute the sheet-processing (for example, any gluing-binding process of a perfect binding process, or a top gluing-binding process) by the gluing-binding machine 200-3b. This job is referred to as “gluing-binding job”. When this gluing-binding job is processed by the printing system 1000 of FIG. 3, the control unit 205 causes the sheet, which is printed by the printing apparatus 100, to be fed to an inside of the gluing-binding machine 200-3b through the points A and B of FIG. 3. After that, the control unit 205 causes the gluing-binding machine 200-3b to execute the gluing-binding process for this job. The control unit 205 does not cause the printed sheet, whose gluing-binding process is executed by the gluing-binding machine 200-3b, to be fed to other apparatus (for example, the apparatus in a post-stage), but causes the printed sheet to be directly held in a sheet-ejecting destination Y inside the gluing-binding machine 200-3b. Meanwhile, when the perfect binding process is executed, a previously-printed cover sheet can be also utilized. In this case, the sheet which becomes this cover sheet is set to a tray Yo.

In the system configuration of FIG. 3, it is assumed that the job to be processed, whose printing execution request is received from the user, is the job which is instructed to execute the sheet-processing by the saddle finisher 200-3c. This sheet processing by saddle finisher 200-3c includes, for example, the saddle stitching process, the punching process, the cutting process, a shift sheet-ejecting process, the folding process, and the like. Here, this job is referred to as “saddle stitching job”.

When this saddle stitching job is processed by the printing system 1000 of FIG. 3, the control unit 205 causes the sheet, which is printed by the printing apparatus 100, to be fed to the saddle finisher 200-3c through the points A, B, and C of FIG. 3. After that, the control unit 205 causes the saddle finisher 200-3c to execute the sheet-processing for this job. The control unit 205 causes the printed sheet of the saddle stitching job, whose sheet-processing is executed by this saddle finisher 200-3c, to be held in a sheet-ejecting destination of the saddle finisher 200-3c. Meanwhile, this saddle finisher 200-3c includes an inserter tray Zo for supplying the previously-printed sheet. For example, a previously-printed cover sheet, or the like are set in this inserter tray Zo. The sheet supplied from this inserter tray Zo is merged with the sheet from the printing apparatus 100. Next, the post-processing which causes such sheets to be a bundle is executed by this saddle finisher 200-3c.

This saddle finisher 200-3c includes a plurality of the sheet-ejecting destinations (Z-1, Z-2, and Z-3). Such sheet-ejecting destinations are utilized to sort the sheets for each of a plurality of types of the sheet-processing which can be executed by the saddle finisher 200-3c. For example, the Z-3 is the sheet-ejecting destination (booklet holding unit) of the printed sheet for which the saddle stitching process is executed by this apparatus. The Z-2 is the sheet-ejecting destination (stack tray) of the printed sheet for which any of a stapling process, the punching process, and the folding process is executed by this apparatus. The Z-1 is the sheet-ejecting destination (sample tray) which is utilized when such a sheet processing is not executed, and the printed sheet is directly ejected.

Meanwhile, the large-capacity stacker 200-3a includes an escape tray Xo as an external sheet-ejecting destination. When the sheet, which is not adopted as final deliverables, is fed from the upstream apparatus, this escape tray Xo is utilized to eject such a sheet. For example, it is possible to eject, to this escape tray Xo, the sheet (stagnant sheet existing in the apparatus) that has been already fed at the time when a printing interrupt factor, such as a case that the sheet being fed is jammed (hereinafter, described as a sheet jam), occurs, and the multi-fed sheet. Thereby, such a sheet can be ejected to an outside of the apparatus without feeding the sheet to the downstream apparatus.

As described above, in the printing system 1000 according to the present embodiment, a plurality of the sheet-processing apparatuses can be connected to the printing apparatus 100. A plurality of such sheet-processing apparatuses can be connected, in any combination, to the printing apparatus 100. A connection order of a plurality of such sheet-processing apparatuses can be also freely changed within such a range that the sheet-feeding path can be linked between the apparatuses. There also exist a variety of candidates of the sheet-processing apparatuses, which can be connected to the printing apparatus 100.

<External View of Operation Unit>

FIG. 4 is an external view of the operation unit 204 of the printing apparatus 100 according to the present embodiment.

This operation unit 204 is provided with the touch panel unit 401, and the key input unit 402. The touch panel unit 401 is provided with a liquid crystal display unit and a transparent electrode applied on the liquid crystal display unit, and displays a variety of setting screens for receiving an instruction from the user. This touch panel unit 401 includes a function for displaying a variety of screens, and an instruction inputting function for receiving the instruction from the user. The key input unit 402 is provided with a power key 501, a start key 503, a stop key 502, a guide key 504, a user mode key 505, and a ten-digit keypad 506. The start key 503 is used when the printing apparatus 100 is caused to start executing a copying job and a transmitting job. The ten-digit keypad 506 is used when a numerical value input, such as the number of copies to be printed, is set.

The control unit 205 controls the printing system 1000 to execute a variety of processes based on a user instruction received through a variety of screens displayed on this touch panel unit 401 and the user instruction received through the key input unit 402.

The touch panel unit 401 displays a mode button for setting modes of a variety of operations such as copy, transmission, box, and expansion, and a variety of instruction buttons for executing print magnification setting, and sheet setting. Since a variety of such instruction buttons are well-known, the description for the buttons will be omitted, and such a case will be described that a sheet processing setting button 609 is touched.

<Setting Screen>

Next, an exemplary setting screen will be described, which is displayed on the touch panel unit 401 of the operation unit 204 of the printing apparatus 100.

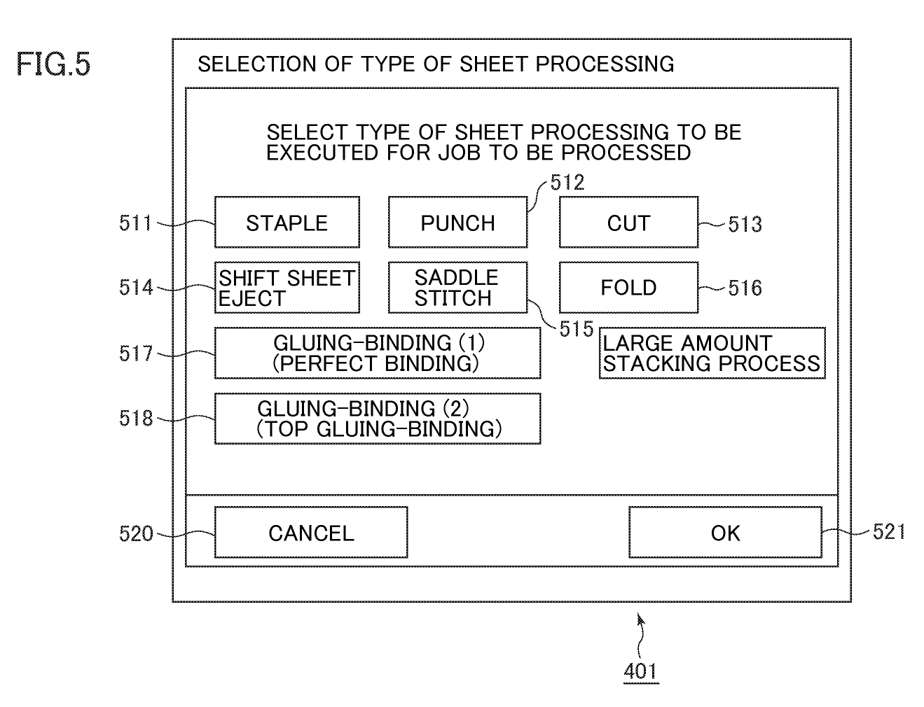

FIG. 5 is a display screen view showing an exemplary screen displayed on the touch panel unit 401 when the sheet processing setting button 609 shown in FIG. 4 is touched.

By using this screen, the user can select a type of the sheet processing which can be executed by using the sheet-processing apparatus 200 included in this printing system 1000.

A reference numeral 511 denotes a button for instructing the stapling process, a reference numeral 512 denotes a button for instructing the punching process, and a reference numeral 513 denotes a button for instructing the cutting process. Reference numerals 514, 515, and 516 denote buttons for instructing the shift sheet-ejecting process, the saddle stitching process, and the folding process, respectively. A reference numeral 517 denotes a button for instructing the gluing-binding (perfect binding) process, and a reference numeral 518 denotes a button for instructing the gluing-binding (top gluing-binding) process. A cancel button 520 is used when cancelling all of such settings, and an OK button 521 is used when activating such settings.

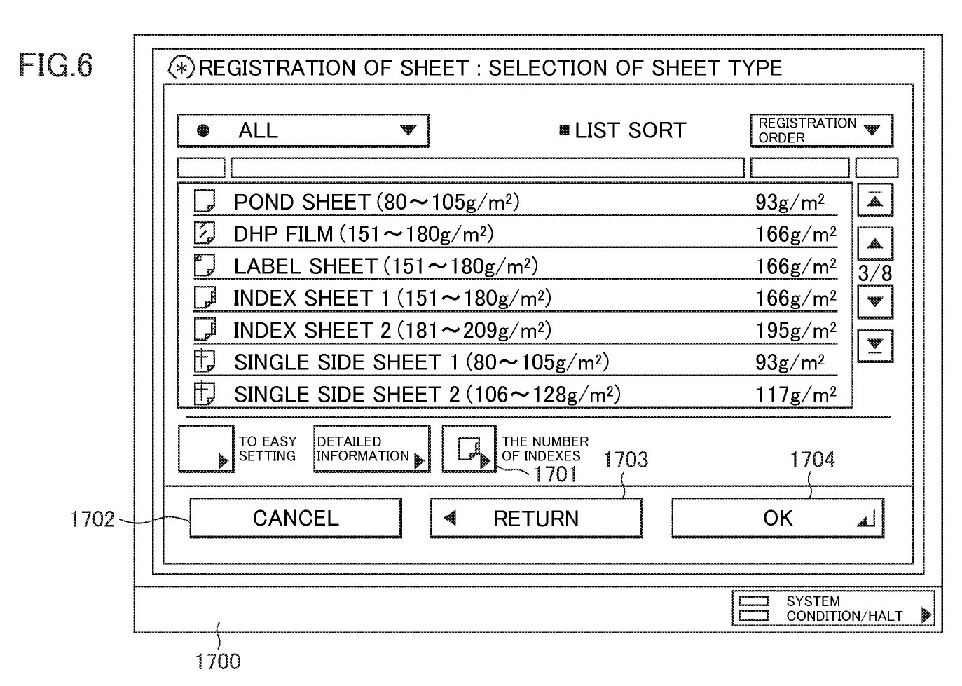

FIG. 6 is a display screen view showing a screen for setting material of the sheet stored in the sheet feeder.

After storing the sheet in the sheet feeder, the user can set the material of the stored sheet on such a screen. As shown in FIG. 6, in a screen 1700 for setting the material of the sheet stored in the sheet feeder, a type of the material is displayed, which can be set by the user. The control is executed so that a “the number of indexes” button 1701 is displayed when the tab sheet is selected, and the “the number of indexes” button 1701 is not displayed when the material other than the tab sheet is selected.

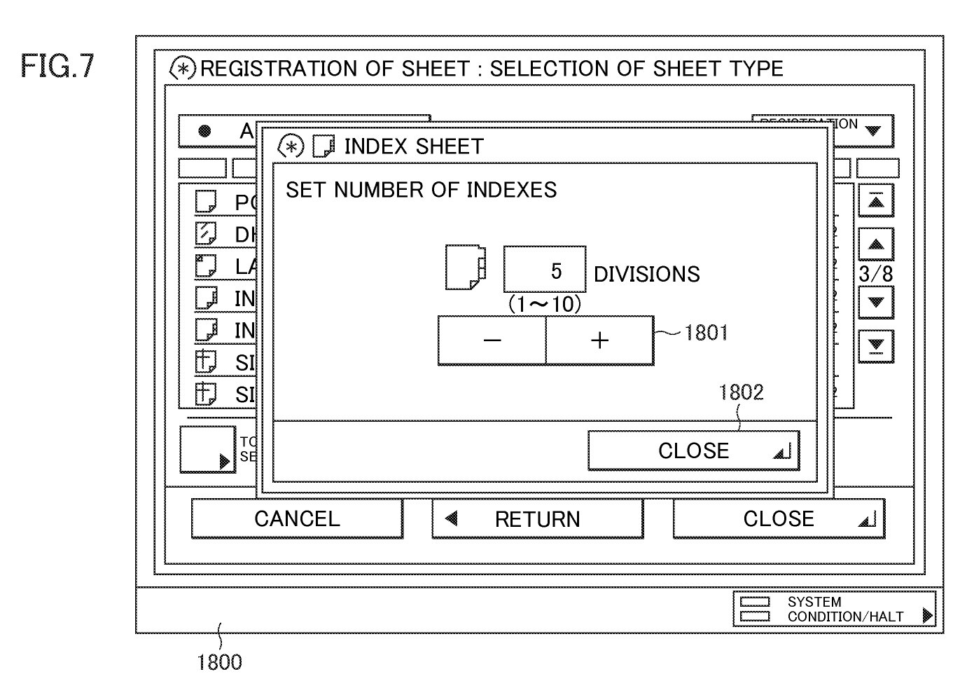

The screen displayed when the “the number of indexes” button 1701 is pressed will be described later by using FIG. 7. The screen 1700 is configured with a cancel button 1702, a return button 1703, and an OK button 1704. When the cancel button 1702 is pressed, the control is executed so as to halt the registering of the sheet stored in the sheet feeder. When the return button 1703 is pressed, the control is executed so as to halt the material-setting of the sheet stored in the sheet feeder, and to return to the previous step in the registering of the sheet stored in the sheet feeder. For example, the process returns to the screen for setting a size of the sheet stored in the sheet feeder. When the OK button 1704 is pressed, set content is registered.

FIG. 7 is a display screen view showing a screen for setting the number of divisions of the tab sheet stored in the sheet feeder.

The user can set the number of divisions of the tab sheet on such a screen. As shown in FIG. 7, a screen 1800, on which the number of divisions of the tab sheet stored in the sheet feeder is set, is configured with a “−/+” button 1801, and a “close” button 1802. When “−” of the “−/+” button 1801 is pressed, the number of divisions displayed in the screen is decreased, and “+” is pressed, the number of divisions displayed in the screen is increased. When the “close” button 1802 is pressed, the number of divisions displayed in the screen is registered.

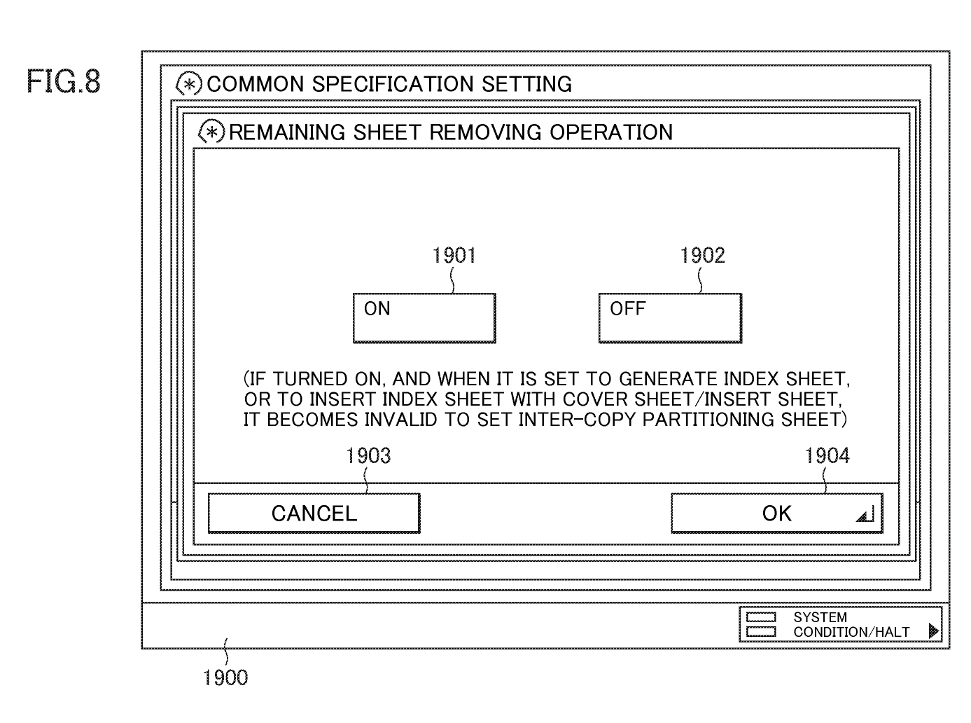

FIG. 8 is a display screen view showing a selection screen for setting a “remaining sheet removing operation” function.

This selection screen is configured so that the user can set whether or not to execute the remaining sheet removing operation before the printing is started. The following is a “remaining sheet removing operation” function. That is, for example, when the printing is interrupted, and when the tab sheet remains in the sheet feeder, the order of the tab sheet becomes wrong. Such a function executes the sheet removing operation for automatically removing the sheet from the sheet feeder to avoid such a disadvantage. The sheet feeder can supply, one by one, a set of sheets configured with a plurality of the tab sheets corresponding to the predetermined number of sheets to the transferring drum 305 side. The remaining sheet is included in a set of the above sheets, and is the tab sheet to be forcibly ejected, which is remaining in the sheet feeder as the sheet unsupplied to the transferring drum 305 side.

As shown in FIG. 8, a screen 1900 for setting the “remaining sheet removing operation” function is configured with an ON button 1901, an OFF button 1902, a cancel button 1903, and an OK button 1904. When the ON button 1901 is pressed, the “remaining sheet removing operation” function is activated, and by contraries, when the OFF button 1902 is pressed, the “remaining sheet removing operation” function is inactivated. When the cancel button 1903 is pressed, it is halted to register content set by the ON button 1901 or the OFF button 1902 of the screen 1900, and when the OK button 1904 is pressed, the content is registered which is set by the ON button 1901 or the OFF button 1902 of the screen 1900.

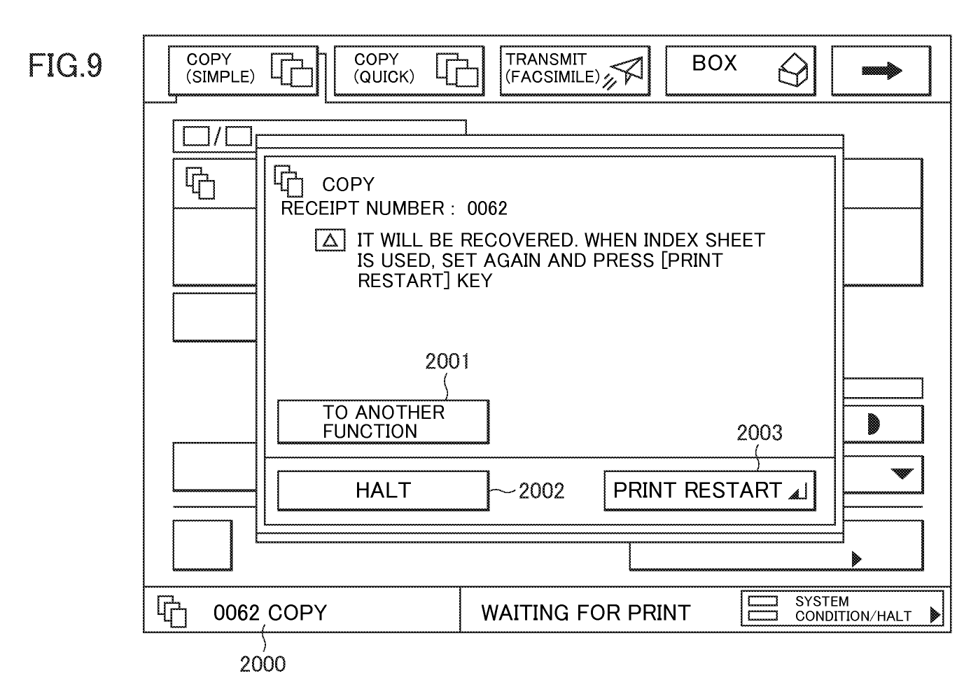

FIG. 9 is a display screen view showing a restart screen of the printing job (hereinafter, described as tab sheet job) utilizing the tab sheet. Such a screen shows an example of the screen displayed after a jam is eliminated when the jam occurs in the tab sheet job.

As shown in FIG. 9, a restart screen 2000 of the tab sheet job is configured with a “to another function” button 2001, a halt button 2002, and a printing restart button 2003. When the “to another function” button 2001 is pressed, the control for the tab sheet job, which is being executed, is interrupted, and the process transits to a control screen of another operation mode of a transmission function, a box function, or the like. When the halt button 2002 is pressed, the control for the tab sheet job, which is being executed, is halted.

When the printing restart button 2003 is pressed, the printing control for the tab sheet job which is being executed, or the remaining sheet removing operation is restarted. If the printing control for the tab sheet job, or the remaining sheet removing operation is automatically restarted after the jam is eliminated, the beginning tab of the tab sheets stored in the sheet feeder may not be appropriately set. Thus, by restarting the printing control for such a tab sheet job or the remaining sheet removing operation, after the printing restart button 2003 is pressed, an inappropriate output sheet is not produced.

<Function of the Remaining Sheet Removing Operation>

Next, a function of the remaining sheet removing operation will be described in detail.

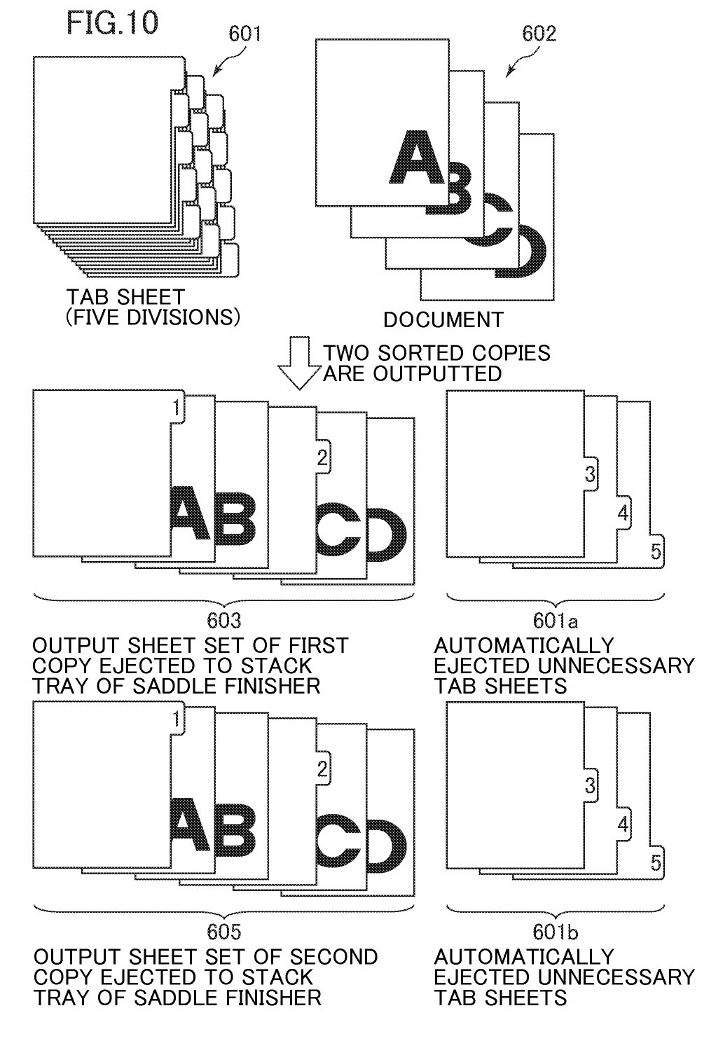

FIG. 10 is a schematic view showing an outline of the function of the remaining sheet removing operation.

In FIG. 10, a tab sheet 601 is shown as an example of the tab sheet used by the tab sheet job. As shown above, the tab sheet normally corresponds to a set of a plurality of the sheets obtained by dividing the tabs to the arbitrary number of divisions. The tab sheet 601 shows that three sets of the tab sheets divided to five divisions are included. The document 602 shows an example of a document bundle used for the tab sheet job.

It is assumed that the sheet, in which the image of the document 602 is printed, is set in a storing location other than the sheet feeder in which the above tab sheet 601 is set. For example, in the system configuration of FIG. 3, the tab sheet 601 is set in the sheet-feeding cassette 317, and the sheet, in which the image of the document 602 is printed, is set in the sheet-feeding deck 319.

Output sheet sets 603 and 605, and tab sheets 601a and 601b show a result obtained by inserting the tab sheet 601 to the first page and the third page of the document 602, and outputting two sorted copies. The output sheet set 603 shows a first output result, and an example of the ejecting destination of this output sheet set is the stack tray Z-2 of the above saddle finisher 200-3c, to which the control unit 205 controls to eject this output sheet set. The tab sheet set 601a shows the unnecessary tab sheets outputted after the output sheet set 603, and an example of the ejecting destination of this output sheet set is the escape tray Xo of the large-capacity stacker 200-3a, to which the control unit 205 controls to automatically eject this output sheet set. Similarly, the output sheet set 605 shows a second output result. The tab sheet set 601b shows the unnecessary tab sheets outputted after the output sheet set 605.

As shown by the output sheet sets 603 and 605, the tab sheet job shown in FIG. 10 uses the two tab sheets for each copy. Since the number of divisions of the tab sheet 601 stored in the sheet-feeding cassette 317 is five divisions, when an index sheet of the first tab is used for the second copy, the third to fifth divisions becomes unnecessary. Thus, the control unit 205 controls an ejecting operation so that the unnecessary tab sheets 601a and 601b of the unnecessary third to fifth divisions are automatically ejected every time the outputting of each copy is completed.

By realizing the function of the above remaining sheet removing operation, such an advantage is obtained that the user can omit a work for previously removing the unnecessary sheet from the purchased tab sheets. Further, by separating the ejecting destination of the output sheet sets 603 and 605 which are originally necessary for the user, and the ejecting destination of the tab sheets 601a and 601b which are unnecessary for the user, it can be simplified to pick up the output sheet set.

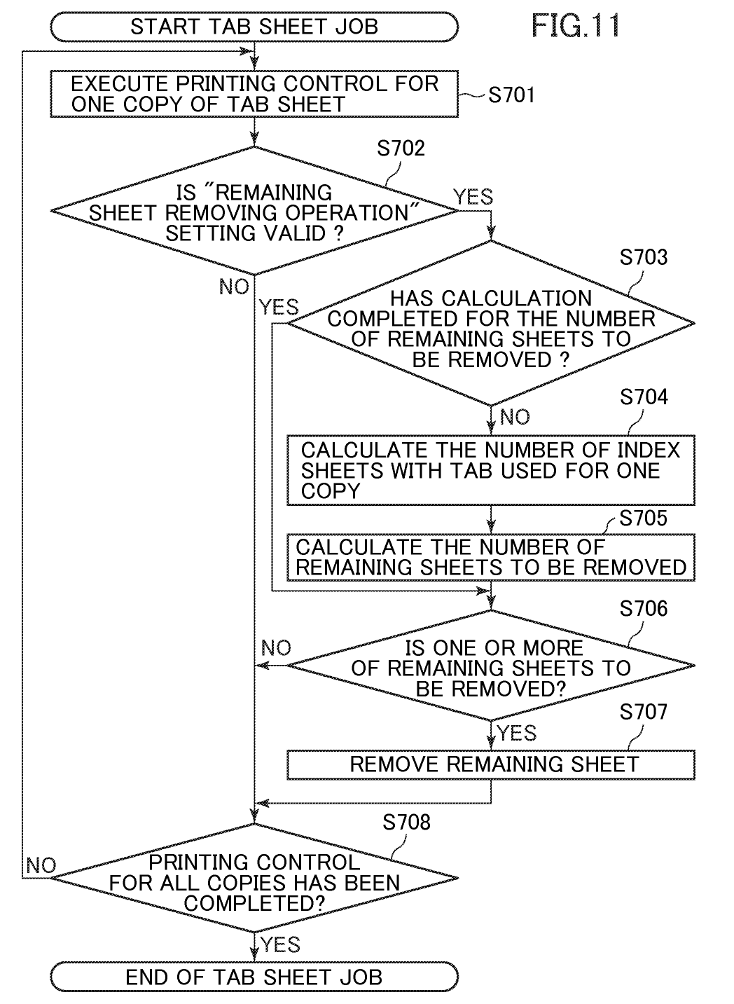

Next, a control flow of the remaining sheet removing operation will be described by using a flowchart of FIG. 11.

FIG. 11 is a flowchart showing a control flow of the remaining sheet removing operation in the printing apparatus 100. A program executing this process is stored in the ROM 207, and is executed under the control of the CPU 205a of the control unit 205.

After receiving the printing execution request for the tab sheet job from the user, the CPU 205a controls to print one copy of such a tab sheet job (S701). After that, it is determined whether the “remaining sheet removing operation” function is active (S702), and when the function is active, the remaining sheet removing operation is continuously controlled.

To control the remaining sheet removing operation, the CPU 205a first determines whether it is completed to calculate the number of the remaining sheets to be forcibly ejected (S703). When such a calculation is not completed, the number of the tab sheets to be utilized for one copy of such a tab sheet job is calculated. Here, it is assumed that “i” (“i” is a natural number) is the number of the tab sheets to be utilized for one copy of such a tab sheet job.

Next, the number of the remaining sheets to be forcibly ejected is calculated (S705). Here, when it is assumed that “I” (“I” is a natural number) is the number of the divisions of the tab sheets stored in the sheet feeder, and mod(i/I) is a remainder obtained by dividing “I” by “i”, the number “M” of the remaining sheets to be forcibly ejected can be calculated with the following mathematical formula.

M=mod((I−mod(i/I)/I)

When the calculation of the number of sheets is completed by this calculation formula, or when it is determined that such a calculation of the number of sheets is completed at S703, the CPU 205a determines whether the number of the remaining sheets to be forcibly ejected, as obtained by the calculation of the number of sheets, is equal to or more than one (S706). When the number of the remaining sheets to be forcibly ejected is not equal to or more than one, the CPU 205a determines that it is not necessary to forcibly eject the remaining sheets, and continuously controls to print the tab sheets of the next copy. When the number of the remaining sheets to be forcibly ejected is equal to or more than one, the calculated number of the remaining sheets are automatically ejected (S707).

After that, the CPU 205a determines whether it is completed to control to print all of the copies (S708), and repeats the above control until it is completed to control to print all of the copies.

<Outline of Processes According to the Present Embodiment>

Next, an outline of the control for the printing interruption according to the present embodiment will be described.

(A) First Printing Interrupt Case

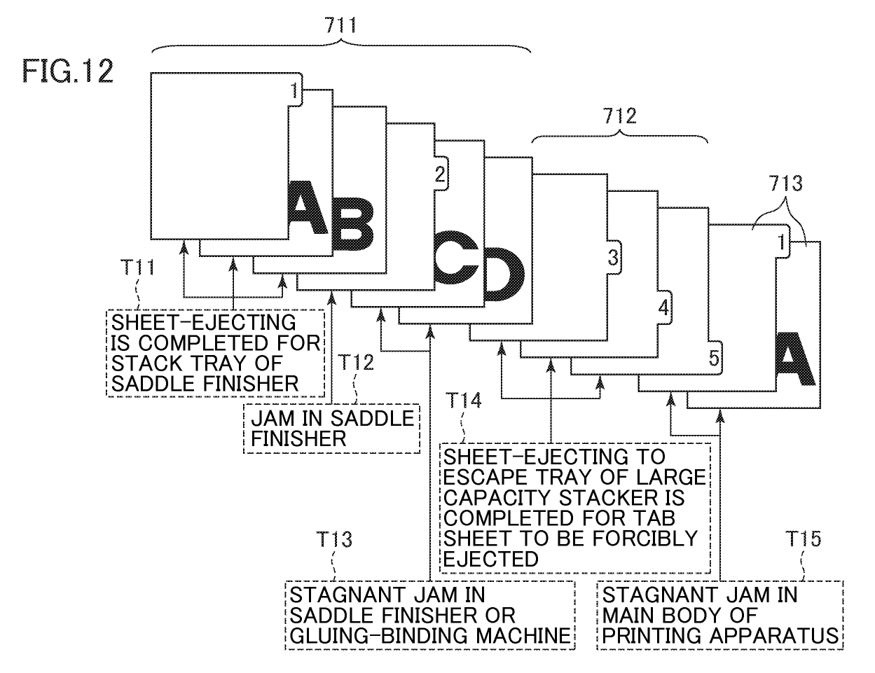

FIG. 12 is a schematic view showing an example of the first printing interrupt case in which the process is interrupted because the sheet jam occurs while the tab sheet job is being processed in the system configuration shown in FIG. 3.

In this example of FIG. 12, a reference numeral 711 denotes a sheet output bundle of the tab sheet job, whose ejecting destination is designated as the stack tray Z-2 of the saddle finisher 200-3c, and a reference numeral 712 denotes the tab sheets (remaining sheet) to be forcibly ejected, whose ejecting destination is designated as the escape tray Xo of the large-capacity stacker 200-3a. A reference numeral 713 denotes the sheets of the second copy of the tab sheet job, whose ejecting destination is designated as the stack tray Z-2 of the saddle finisher 200-3c.

It is completed to correctly eject, to the designated sheet-ejecting destination, the beginning three sheets of the tab sheet job for sheet-ejecting a series of such sheet output bundles (T11), and for the next fourth sheet, the jam occurs in the saddle finisher 200-3c (T12). In this case, since the jam occurs for the preceding fourth sheet, for the fifth and sixth sheets, which are simultaneously fed, a stagnant jam occurs in the saddle finisher 200-3c, or the gluing-binding machine 200-3b (T13). However, the subsequent tab sheet (remaining sheet) to be forcibly ejected can be ejected to the escape tray Xo of the designated large-capacity stacker 200-3a (T14). The sheet of the tab sheet job for the second copy cannot be ejected to the designated sheet-ejecting destination (the stack tray Z-2 of the saddle finisher 200-3c), so that the stagnant jam occurs in the printing apparatus (T15). As described above, such a tab sheet job is interrupted.

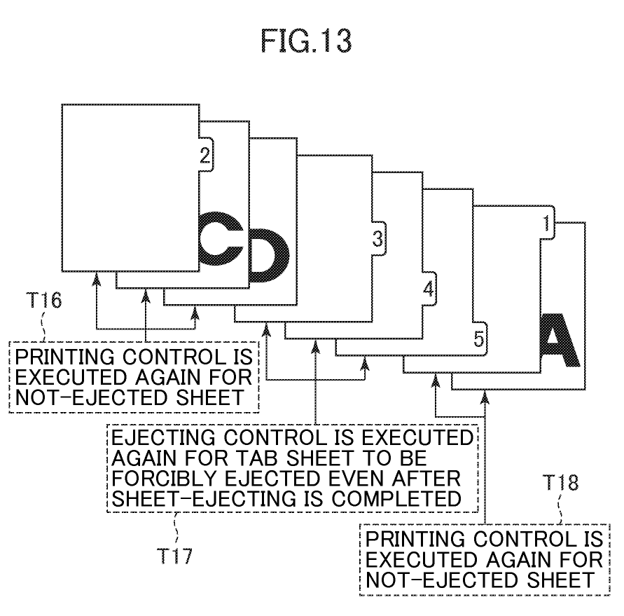

FIG. 13 is a schematic view showing job restarting control after the printing interruption shown in FIG. 12.

In this example of FIG. 13, after the jam is eliminated from the printing interrupt condition shown in FIG. 12, the reprinting control is executed for the sheet output bundle of the first copy, which has not been normally ejected (T16), next, the re-ejecting control is executed for the remaining sheet to be forcibly ejected, which has been normally ejected (T17). Next, the printing control is executed again for the sheet output bundle of the second copy, which has not been ejected (T18).

As described above, when the tab sheet is included in the preceding sheet output bundle not to be forcibly ejected, even if the ejecting for the tab sheet to be forcibly ejected is completed, the ejecting control is executed again. By executing such a control, the correct output sheet set can be provided to the user without the incorrect order of the tab sheet. That is, when the reprinting control is executed for only the sheet, whose ejecting is not correctly completed, after the jam is eliminated from the printing interrupt condition shown in FIG. 12, the following is processed in the example of FIG. 12. That is, since the remaining sheet to be forcibly ejected has been already correctly ejected, the ejecting control is not executed again after the jam is eliminated. As a result, the tab sheet in the incorrect order is outputted in the tab sheet job of the second copy. That is, if the tab sheet to be forcibly ejected, whose ejecting is completed, is not re-ejected, the order of the tab sheet to be used in the next copy becomes incorrect.

(B) Second Printing Interrupt Case

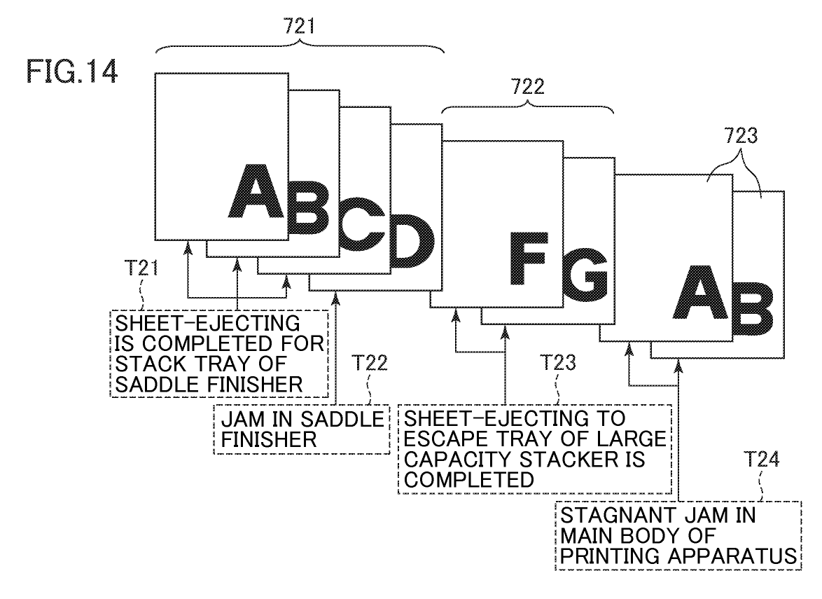

FIG. 14 is a schematic view showing an example of a second printing interrupt case in which the process is interrupted because the sheet jam occurs while the printing job other than the tab sheet job is being processed in the system configuration shown in FIG. 3.

In the job shown in FIG. 14, it is assumed as follows. The stack tray Z-2 of the above saddle finisher 200-3c is designated as the ejecting destination of a sheet output bundle 721 of the beginning four pages. And, the escape tray Xo of the large-capacity stacker 200-3a is designated as the ejecting destination of a sheet output bundle 722 of the next two pages. Further, such a job outputs a plurality of the above sheet output bundles.

In the example of FIG. 14, it is normally completed to eject the beginning first to third sheets whose ejecting destination is designated to be the stack tray Z-2 of the above saddle finisher 200-3c (T21), and for the subsequent fourth sheet, the jam occurs in the saddle finisher 200-3c (T22). In this case, the fifth and sixth sheets, which are simultaneously fed, can be normally ejected to the designated large-capacity stacker 200-3a (T23). Since the sheets 723 of the second copy cannot be ejected to the designated ejecting destination (the stack tray Z-2 of the above saddle finisher 200-3c), the stagnant jam occurs in the printing apparatus 100 (T24). As described above, such a job is interrupted.

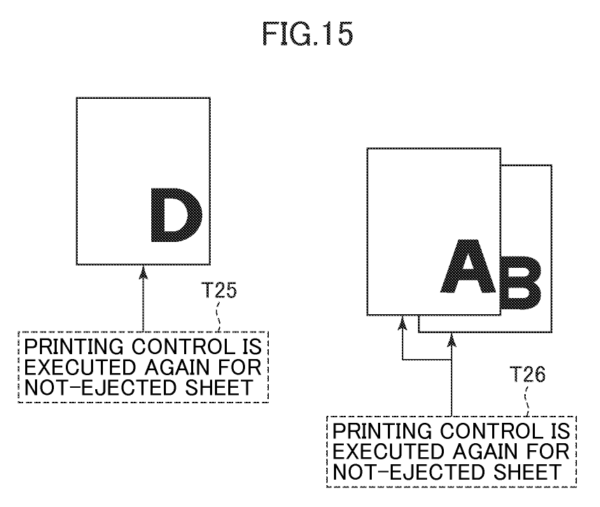

FIG. 15 is a schematic view showing the job restarting control after the printing interruption shown in FIG. 14.

In the second printing interrupt case shown in FIG. 14, it is enough to execute the printing control again only for the sheet whose ejecting is not completed. On the other hand, if the reprinting control is also executed for the sheet whose ejecting is completed, the output sheet set is duplicated, and also, the extra control is executed, so that the high productivity cannot be maintained.

In other words, when the jam occurs, and when the normally-ejected sheet is the remaining sheet to be forcibly ejected, the control unit 205 controls to execute the reprinting or the re-ejecting after the jam is eliminated. Further, when the jam occurs, and when the normally-ejected sheet is not the remaining sheet to be forcibly ejected, the control unit 205 controls not to execute the reprinting or the re-ejecting after the jam is eliminated. By executing such a control, it is possible to suppress an inappropriate output result, and to maintain the high productivity.

(C) Third Printing Interrupt Case

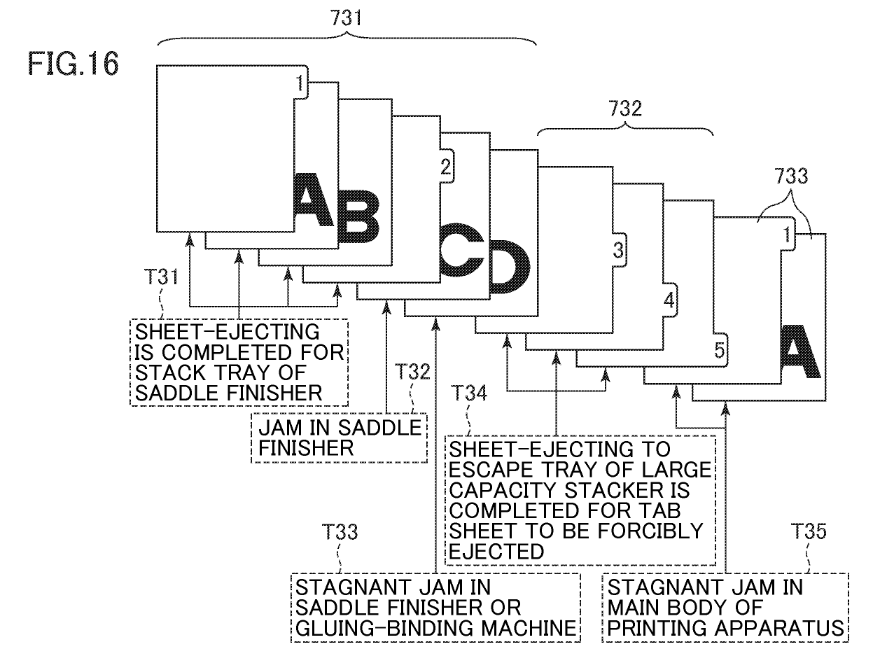

FIG. 16 is a schematic view showing an example of a third printing interrupt case in which the process is interrupted because the sheet jam occurs when the printing control for the tab sheet job or the remaining sheet removing operation are executed in the system configuration shown in FIG. 3.

In this example of FIG. 16, a reference numeral 731 denotes the sheet output bundle of the tab sheet job whose ejecting destination is designated to be the stack tray Z-2 of the above saddle finisher 200-3c, and a reference numeral 732 denotes the tab sheets (remaining sheets) to be forcibly ejected, whose ejecting destination is designated to be the escape tray of the large-capacity stacker 200-3a. A reference numeral 733 denotes the sheets of the second copy of the tab sheet job whose destination is designated to be the stack tray Z-2 of the saddle finisher 200-3c.

In the example of FIG. 16, it is completed to correctly eject the beginning four sheets of the tab sheet job to the designated sheet-ejecting destination (T31), and for the subsequent fifth sheet, the jam occurs in the saddle finisher 200-3c (T32). In this case, because the jam occurs for the preceding fifth sheet, for the sixth sheet, the stagnant jam occurs in the saddle finisher 200-3c or the gluing-binding machine 200-3b (T33). However, the subsequent tab sheet (remaining sheet) to be forcibly ejected can be ejected to the escape tray Xo of the designated large-capacity stacker 200-3a (T34). Since the sheet output bundle of the tab sheet job of the second copy cannot be ejected to the designated sheet-ejecting destination (the stack tray Z-2 of the saddle finisher 200-3c), the stagnant jam occurs in the printing apparatus 100 (T35). As described above, such a tab sheet job is interrupted.

When such an example of FIG. 16 is compared with FIG. 12, the characteristic point of the third printing interrupt case is that in the preceding sheets rather than the remaining sheets to be forcibly ejected, all of the sheets, whose ejecting cannot be completed, are not the tab sheets.

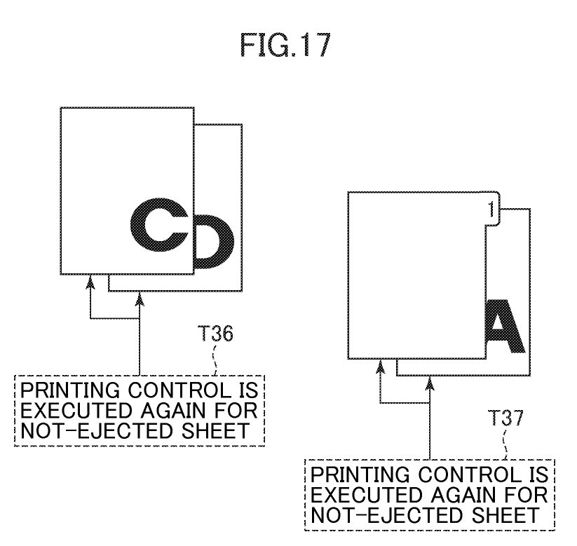

FIG. 17 is a schematic view showing the job restarting control after the printing interruption shown in FIG. 16.

In the example of FIG. 17, such an example is shown that only the reprinting control for the sheet output bundle, whose ejecting is not normally completed, is executed after the jam is eliminated from the printing interrupt condition shown in FIG. 16 (T36 and T37). In the above description, when the jam occurs, and when the normally-ejected sheet is the remaining sheet to be forcibly ejected, the control is executed so that the reprinting or the re-ejecting is executed after the jam is eliminated. However, such a case is also included in the present embodiment that, when the tab sheet is not included in the preceding sheet output bundle, whose ejecting is completed, the control is executed so that the sheet output bundle of the remaining sheet to be forcibly ejected, which is normally ejected, is not reprinted or re-ejected after the jam is eliminated. By controlling as described above, further higher productivity becomes able to be maintained.

For example, such a case is also included in the present embodiment that, when the jam occurs in the tab sheet job, the control is executed so that the unnecessary tab sheet is forcibly ejected just after the jam is eliminated so that the order of the tab sheet is corrected after the jam is eliminated. By controlling as described above, an appropriate output result becomes able to be constantly provided to the user without an extra user operation.

<Process Flow According to the Present Embodiment>

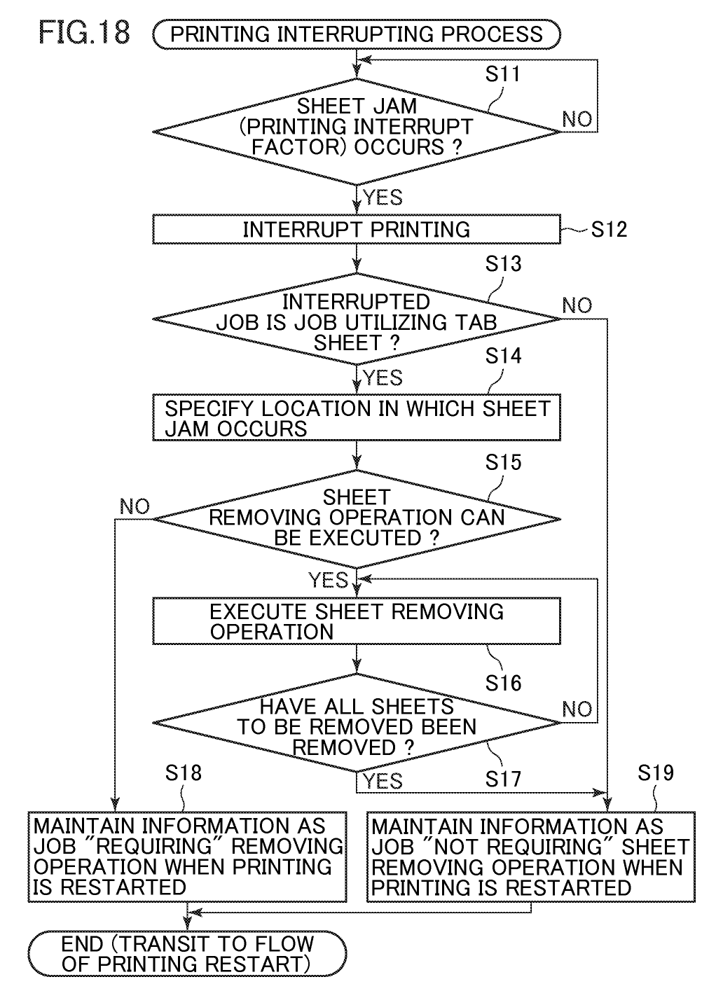

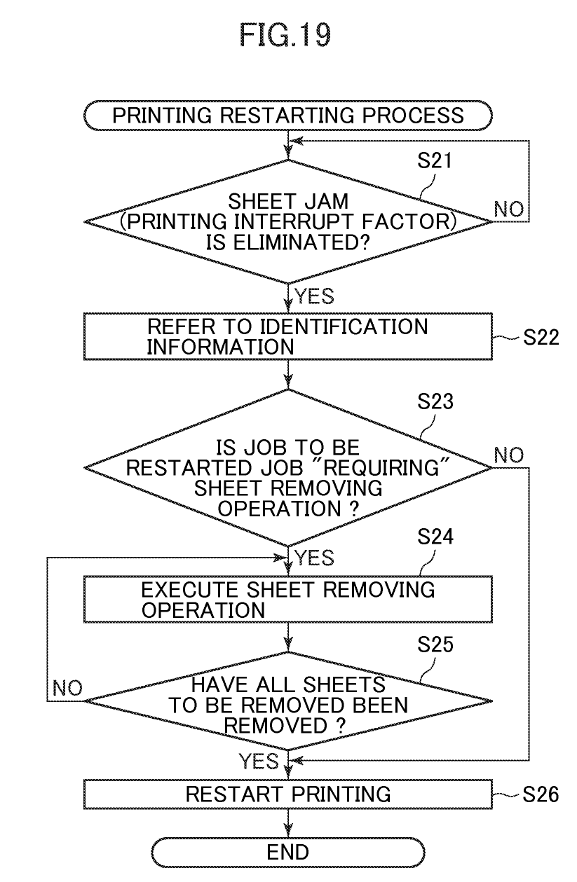

Next, a process flow of the printing apparatus 100 according to the present embodiment will be described by referring to FIG. 18 and FIG. 19.

(A) Process in the Printing Interruption

FIG. 18 is a flowchart showing a process when the printing is interrupted in the printing apparatus 100 according to the present embodiment. Meanwhile, a program executing this process is stored in the ROM 207, and is executed under the control of the CPU 205a of the control unit 205.

The CPU 205a monitors whether or not the printing interrupt factor such as the sheet jam occurs (S11), and when the sheet jam occurs, the printing process is interrupted (S12). Next, the CPU 205a determines whether the interrupted job is a job (tab sheet job) which utilizes the ordered sheet, or the tab sheet (S13). When the interrupted job is the tab sheet job, the CPU 205a receives a detection signal of a detecting component such as a photo sensor provided in, for example, the sheet-feeding path, and specifies a location in which the sheet jam occurs (S14).

When the sheet jam as the interrupt factor occurs in the sheet-feeding path in a more downstream side in a sheet-feeding direction than the predetermined ejecting destination, the CPU 205a determines that the remaining sheet removing operation (sheet removing operation) for the remaining sheet can be executed. When the sheet jam occurs in the sheet-feeding path in a more upstream side (S15), the CPU 205a determines that the remaining sheet removing operation cannot be executed.

When the remaining sheet removing operation cannot be executed, information indicating that the job requires the remaining sheet removing operation when the printing is restarted is held in the RAM 208. On the other hand, when the remaining sheet removing operation can be executed, the remaining sheet removing operation is executed, and all of the remaining sheets to be ejected are ejected from the sheet-feeding cassette 317 of FIG. 3 (S17). Identification information indicating that the job does not require the remaining sheet removing operation when the printing is restarted is then held in the RAM 208 in association with the interrupted job (S19). In the determination at S13, when the interrupted job is not the tab sheet job, identification information indicating that the job does not require the remaining sheet removing operation when the printing is restarted is also held in the RAM 208 in association with the interrupted job (S19).

As described above, the CPU 205a holds the identification information in the RAM 208 so that the identification information can be referred to when the printing interrupt factor is eliminated, and the printing is restarted.

(B) Process in the Printing Restart

FIG. 19 is a flowchart showing a process when the printing is restarted in the printing apparatus 100 according to the present embodiment.

The printing restart for the interrupted job is controlled to be executed on such a condition that an execution instruction is received from the user through a user interface (the printing restart button 2003 of FIG. 9) after the printing is interrupted.

When receiving the execution instruction for the printing restart from the user because the printing restart button 2003 is pressed, the CPU 205a monitors whether or not the printing interrupt factor such as the sheet jam is eliminated for the interrupted job (S21). When the sheet jam is eliminated, the CPU 205a referred to the identification information held in the RAM 208 when the printing is interrupted (S22). Next, the CPU 205a determines based on this identification information whether or not such an interrupted job is the job that requires the remaining sheet removing operation (S23).

If the interrupted job is the job requiring the remaining sheet removing operation, the CPU 205a executes the removing operation until all of the remaining sheets to be removed are ejected from the sheet-feeding cassette 317 of FIG. 3 (S24, S25). This control is executed even when the execution instruction is not received from the user through the user interface after the printing is interrupted.

When it is completed to removed all of the remaining sheets from the sheet-feeding cassette 317, the CPU 205 restarts the printing (S26). That is, if the remaining sheet removing operation is not completed at the time when the printing is interrupted, the CPU 205a controls to execute the remaining sheet removing operation at the time when the printing is restarted. That is, if the CPU 205a has determined that the remaining sheet removing operation cannot be executed at S15, the process proceeds to S18, the determination is YES at S23, and the process proceeds to S24.

On the other hand, if it is determined based on the identification information indicating that such an interrupted job is the job not requiring the remaining sheet removing operation, the CPU 205a skips the processes at S24 and S25, and proceeds to S26 to restart the printing.

That is, when the interrupted job is the job which utilizes the disordered sheet and does not utilize the ordered sheet (tab sheet), the CPU 205 executes as follows. That is, the CPU 205 controls to restart the printing of such an interrupted job without executing the remaining sheet removing operation so that the disordered sheet is not removed from the sheet-feeding cassette used by such a job at the time when the printing is restarted. That is, the process proceeds through S13, S19 and S23 and directly to S26. Even when the interrupted job is the job utilizing the tab sheet, and if the remaining sheet removing operation is completed at the time when the printing is interrupted, the CPU 205 controls to restart the printing of such an interrupted job without executing the remaining sheet removing operation at the time when the printing is restarted. That is, the process proceeds from S17 to S19, and the determination becomes NO at S23, so that the process does not proceed to S24, but directly proceeds to S26.

Meanwhile, the ordered sheet is at least any of the sheet with a tab portion, or the sheet which is previously provided with a page number.

<Advantages According to the Present Embodiment>

The present embodiment has the following advantages.

(1) When an interrupted job is a job utilizing the tab sheet (the ordered sheet), the removing operation is executed for the tab sheet remaining in the sheet-feeding cassette. Thereby, such a mechanism can be provided that, even if an interrupted job is a job utilizing a tab sheet, a disordered tab sheet which is not intended by the user is prevented from being supplied from the sheet-feeding cassette after the interruption.

(2) When a job utilizing the tab sheet is interrupted, the removing operation for the tab sheet is executed so that the remaining tab sheet is removed from the sheet-feeding cassette utilized in such a job. If this removing operation is not completed at the time when the printing is interrupted, the removing operation for the tab sheet is executed at the time when the printing of such a job is restarted. On the other hand, when the removing operation for the tab sheet is completed at the time when the printing is interrupted, the control is executed so that the printing of such a job is restarted without executing the removing operation for the tab sheet at the time when the printing of such a job is restarted. Thereby, the printing can be rapidly restarted in a less wasteful operation.

(3) The printing system 1000 of the present embodiment receives a first job which utilizes at least an ordered sheet (a tab sheet, or the like) in the printing, and a second job which utilizes a disordered sheet in the printing, and does not utilize the ordered sheet in the printing. When the interrupted job is the first job, the control is executed so that the printing of the first job is restarted after the sheet removing operation is executed so as to remove the ordered sheet from the sheet-feeding cassette utilized in the first job. When the interrupted print job is the second job, the control is executed so that the printing of the second job is restarted without executing the sheet removing operation so as not to remove the disordered sheet from the sheet-feeding cassette utilized in the second job. Thereby, a less wasteful and rapid printing restart can be realized for both cases where an interrupted job is a job utilizing an ordered sheet, and where such a job is a job utilizing a disordered sheet.

<Modified Example of the Process According to the Present Embodiment>

The process of the present invention is not limited to the process according to the above embodiment described in FIG. 18 and FIG. 19, and a variety of modifications can be executed. The following is, for example, the modified example.

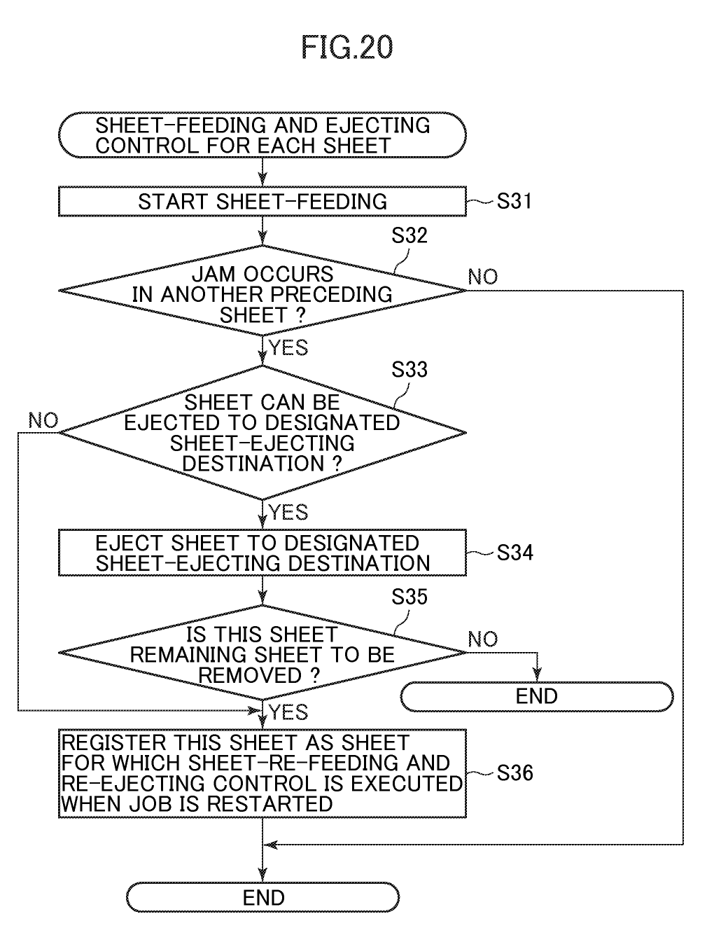

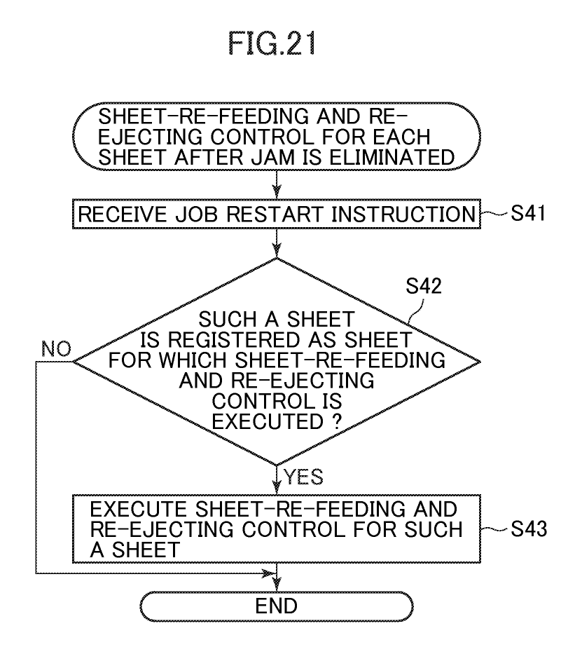

FIG. 20 and FIG. 21 are flowcharts showing modified examples of the process in the printing apparatus 100 of the above embodiment. A program for executing this process is stored in the ROM 207, and is executed under the control of the CPU 205a of the control unit 205.

FIG. 20 is a flowchart showing a procedure of the sheet-feeding and ejecting control for each sheet.

After the printing execution request is received from the user, the sheet-feeding control is executed for each sheet according to the above paper-handling control (S31). When the supplied sheet can be normally fed without a jam while such a supplied sheet is being fed to the designated ejecting destination, such a sheet to be controlled is directly ejected to the designated sheet-ejecting destination (S34), and the sheet-feeding and ejecting control for such a sheet is completed.

On the other hand, when the jam occurs for another preceding sheet while such a supplied sheet is being fed to the designated sheet-ejecting destination (S32), it is determined whether such a sheet can be ejected to the designated sheet-ejecting destination (S33). When such a sheet can be ejected, such a sheet is directly ejected to the designated sheet-ejecting destination (S34). For example, in the system configuration of FIG. 3, when the sheet is controlled, whose sheet-ejecting destination is designated to be the escape tray Xo of the large-capacity stacker 200-3a, the following is executed. That is, when the preceding sheet is not remaining in the feeding path to the escape tray Xo of the large-capacity stacker 200-3a, and the control is executed so that the sheet-ejecting control is continued for such a sheet to the designated sheet-ejecting destination even if the jam occurs.

Next, it is determined whether such a sheet is the remaining sheet to be forcibly ejected (S35). When such a sheet is not the remaining sheet, the sheet-feeding and ejecting control for such a sheet is directly completed. When it can be determined at S35 that such a sheet is the remaining sheet, such a sheet is registered as the sheet for which the re-feeding and re-ejecting control is executed when the job is restarted (S36). When it is determined at S33 that such a sheet cannot be ejected to the designated sheet-ejecting destination, such a sheet is also registered as the sheet for which the re-feeding and re-ejecting control is executed when the job is restarted (S36), and the sheet-feeding and ejecting control for such a sheet is completed.

FIG. 21 is a flowchart showing a procedure of the sheet-feeding and ejecting control for each sheet after the jam is eliminated.

When the jam occurs while the sheet-feeding and ejecting control for each sheet is being executed, after the jam is eliminated, the control is executed in a procedure shown in the flowchart of FIG. 21.

When the jam is eliminated, the sheet-feeding control is executed again for each sheet according to the paper-handling control. When the jam is eliminated, and the restarting instruction for the job is received from the user (S41), it is determined whether the sheet to be controlled is registered at S36 as the sheet for which the re-feeding and re-ejecting control is executed (S42). When the sheet to be controlled is registered, the feeding and rejecting control for the sheet is executed again (S43), and when the sheet to be controlled is not registered, the control for the sheet is terminated.

Meanwhile, the present embodiment may be also configured as follows. Instead of the control unit 205 provided in the printing apparatus 100, a control unit (CPU) of an external apparatus such as the client PC 104 and the server PC 103, which are applied as an information processing apparatus, executes a variety of determinations and controls of the above embodiment. Further, a plurality of such control units executes, as cooperating with each other, a variety of determinations and controls of a variety of the above embodiments. As described above, the present embodiment may be configured so that a variety of the above determinations and controls are realized by one CPU, or by a plurality of the CPUs as cooperating with each other.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of any of the embodiments described above, and hence the program code and the storage medium in which the program code is stored constitute the present invention.

Examples of the storage medium for supplying the program code include a floppy (registered trade mark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program may be downloaded via a network.

Further, it is intended to encompass in the present invention the functions of the above described embodiment accomplished by executing a program code read out by a computer. In addition, it is also intended to encompass the case where an OS (operating system) or the like which executes on the computer performs a part or all of the actual operations based on instructions of the program code to provide for the functions of the above described embodiment.

Further, it is intended to encompass in the present invention the functions of the above described embodiment accomplished as follows: a program code read out from the storage medium is written into a memory provided on an expansion board inserted into a computer or in an expansion unit connected to the computer and a CPU or the like provided in the expansion board or the expansion unit performs a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2008-064577, filed on Mar. 13, 2008, which is hereby incorporated by reference herein in its entirety.

What is claimed is:

1. A printing system, comprising:
a job processing unit configured to execute a job outputting at least one sheet included in a set of a plurality of sheets in a case where sheets printed by a printing operation are outputted; and
a control unit configured to control to output, to a predetermined sheet-ejecting unit, a sheet which has not been outputted by said job processing unit among the set of a plurality of the sheets used by said job when said job executed by said job processing unit is interrupted,
wherein said job processing unit restarts to execute the interrupted job based on an instruction of a user after the sheet which has not been outputted by said job processing unit is outputted to said predetermined sheet-ejecting unit.

2. A printing system according to claim 1, further comprising:
a determining unit configured to determine whether or not the sheet which has not been outputted by said job processing unit among the set of a plurality of the sheets can be outputted by said control unit to said predetermined sheet-ejecting unit while said job is interrupted,
wherein said control unit controls to output a sheet which has not been outputted by said job processing unit among the set of a plurality of the sheets to said predetermined sheet-ejecting unit while said job is interrupted, when said determining unit determines that the sheet which has not been outputted by said job processing unit among the set of a plurality of the sheets can be outputted to said predetermined sheet-ejecting unit while the job is interrupted, and
wherein said control unit controls to output a sheet which has not been outputted by said job processing unit among the set of a plurality of the sheets to said predetermined sheet-ejecting unit after said job is restarted, when said determining unit determines that the sheet which has not been outputted by said job processing unit among the set of a plurality of the sheets cannot be outputted to said predetermined sheet-ejecting unit while the job is interrupted.

3. A printing system according to claim 1, further comprising:
a setting unit configured to set, before the printing operation is started, whether or not the sheet which has not been outputted by said job processing unit among the set of a plurality of the sheets is outputted to said predetermined sheet-ejecting unit,
wherein said control unit controls to output a sheet which has not been outputted by said job processing unit among the set of a plurality of the sheets to said predetermined sheet-ejecting unit when said setting unit sets so that the sheet which has not been outputted by said job processing unit among the set of a plurality of the sheets is outputted to the predetermined sheet-ejecting unit, and
wherein said control unit controls not to output a sheet which has not been outputted by said job processing unit among the set of a plurality of the sheets to said predetermined sheet-ejecting unit when said setting unit sets so that the sheet which has not been outputted by said job processing unit among the set of a plurality of the sheets is not outputted to the predetermined sheet-ejecting unit.

4. A printing system according to claim 1, further comprising:
a storing unit configured to store information about the sheet which has been outputted by said job processing unit,
wherein said control unit restarts the execution for the interrupted job based on the information stored in said storing unit, when the interrupted job is restarted by said job processing unit.

5. A printing system according to claim 1, further comprising:
a display control unit configured to cause a display unit to display a message for causing the user to confirm a set of a plurality of the sheets used by the job to restart the execution for the interrupted job when the job to be executed by said job processing unit is interrupted.

6. A control method for controlling a printing system, comprising:
performing a job outputting at least one sheet included in a set of a plurality of sheets in a case where the sheets printed by a printing operation are outputted;
outputting a sheet which has not been outputted by said job among the set of a plurality of the sheets used by said job to a predetermined sheet-ejecting unit when said job is interrupted; and
restarting the performing for the interrupted job based on an instruction of a user after the sheet which has not been outputted is outputted to said predetermined sheet-ejecting unit.

7. A control method according to claim 6, further comprising:
determining whether or not the sheet which has not been outputted among the set of a plurality of the sheets can be outputted to said predetermined sheet-ejecting unit while the job is interrupted,
wherein a sheet which has not been outputted by said job among the set of a plurality of the sheets is outputted to said predetermined sheet-ejecting unit while said job is interrupted, when it is determined that the sheet which has not been outputted among the set of a plurality of the sheets can be outputted to said predetermined sheet-ejecting unit while the job is interrupted, and
wherein a sheet which has not been outputted by said job among the set of a plurality of the sheets is outputted to said predetermined sheet-ejecting unit after said job is restarted, when it is determined that the sheet which has not been outputted among the set of a plurality of the sheets cannot be outputted to said predetermined sheet-ejecting unit while the job is interrupted.

8. A control method according to claim 6, further comprising:
setting, before the printing operation is started, whether or not the sheet which has not been outputted among the set of a plurality of the sheets is outputted to said predetermined sheet-ejecting unit,
wherein a sheet which has not been outputted by said job among the set of a plurality of the sheets is outputted to said predetermined sheet-ejecting unit, when it is set that the sheet which has not been outputted among the set of a plurality of the sheets is outputted to said predetermined sheet-ejecting unit, and
wherein a sheet which has not been outputted by said job among the set of a plurality of the sheets is not outputted to said predetermined sheet-ejecting unit, when it is set that the sheet which has not been outputted among the set of a plurality of the sheets is not outputted to said predetermined sheet-ejecting unit.

9. A control method according to claim 6, further comprising:
storing information about the sheet which has been outputted in a storing unit,
wherein the performing for the interrupted job is restarted based on said information stored in said storing unit, when the interrupted job is restarted.

10. A control method according to claim 6, further comprising:
causing a display unit to display a message for causing the user to confirm a set of a plurality of the sheets used by the job to restart the execution for the interrupted job when the job is interrupted.

11. A computer-readable storage medium storing a control program for controlling a printing system, the control program comprising:
a code to perform a job outputting at least one sheet included in a set of a plurality of sheets in a case where the sheets printed by a printing operation are outputted;
a code to output a sheet which has not been outputted by said job among the set of a plurality of the sheets used by said job to a predetermined sheet-ejecting unit when said job is interrupted; and
a code to restart executing the interrupted job based on an instruction of a user after the sheet which has not been outputted is outputted to the predetermined sheet-ejecting unit.
